(19) United States
(12) Patent Application Publication
(10) Pub. No.: US 2026/0148753 A1
(43) Pub. Date: May 28, 2026

(54) METHOD, APPARATUS, DEVICE AND PRODUCT FOR ADDING EFFECT

(71) Applicants: Beijing Zitiao Network Technology Co., Ltd., Beijing (CN); Lemon Inc., Grand Cayman (KY)

(72) Inventors: Jinjin WANG, Beijing (CN); Yunpeng JING, Los Angeles, CA (US)

(21) Appl. No.: 19/331,868

(22) Filed: Sep. 17, 2025

(30) Foreign Application Priority Data
Nov. 22, 2024 (CN) 202411688514.0

(51) Int. Cl. G11B 27/031; G11B 27/34

(52) U.S. Cl. CPC G11B 27/031; G11B 27/34

(57) ABSTRACT

The disclosure relates to a method, an apparatus, a device and a product for adding an effect. The method comprises obtaining beat marker information of music of a video, the beat marker information indicating a change in a rhythm of the music. The method further comprises obtaining, variable-speed information for the video, the variable-speed information indicating a playback speed of each video segment of the video. In addition, the method further comprises adding an effect to the video based on the variable-speed information.

### CROSS-REFERENCE TO RELATED APPLICATION(S)

This application claims priority to Chinese Application No. 202411688514.0, filed on Nov. 22, 2024, the disclosure of which is incorporated herein by reference in its entirety.

### FIELD

The disclosure relates to the field of computers, and more specifically to a method, an apparatus, a device and a product for adding an effect.

### BACKGROUND

In the field of video products, each large platform is dedicated to provide users with experience of various effects to meet the users'growing aesthetic and creative demands. The effects in these video products are obtained by processing video materials through technical means including various types such as transition, subtitles, filters, variable speed, audio, etc., aiming to improve visual effects and enhance a viewer's experience.

With the constant development of technologies such as Artificial Intelligence (AI), Virtual Reality (VR) and Augmented Reality (AR), the production of video effects will become more intelligent and automated. A user needs not have professional video editing skills, and may create more unique and attractive works by performing a simple clicking operation or a simple drag-and-drop operation, or using an effect editing tool to incorporate a desired effect into his own video.

### SUMMARY

In a first aspect of embodiments of the present disclosure, there is provided a method for adding an effect. The method comprises: obtaining beat marker information of music of a video, the beat marker information indicating a change in a rhythm of the music. The method further comprises obtaining, based on the beat marker information, variable-speed information for the video, the variable-speed information indicating a playback speed of each video segment of the video. In addition, the method further comprises adding an effect to the video based on the variable-speed information.

In a second aspect of embodiments of the present disclosure, there is provided an apparatus for adding an effect. The apparatus comprises a beat marker information obtainment module configured to obtain beat marker information of music of a video, the beat marker information indicating a change in a rhythm of the music. The apparatus further comprises a variable-speed information obtaining module configured to obtain, based on the beat marker information, variable-speed information for the video, the variable-speed information indicating a playback speed of each video segment of the video. In addition, the apparatus further comprises an effect addition module configured to add an effect to the video based on the variable-speed information.

In a third aspect of embodiments of the present disclosure, there is provided an electronic device. The electronic device comprises: one or more processors; and a storage device for storing one or more programs which, when executed by the one or more processors, cause the one or more processors to implement a method for adding an effect. The method comprises: obtaining beat marker information of music of a video, the beat marker information indicating a change in a rhythm of the music. The method further comprises obtaining, based on the beat marker information, variable-speed information for the video, the variable-speed information indicating a playback speed of each video segment of the video. In addition, the method further comprises adding an effect to the video based on the variable-speed information.

In a fourth aspect of embodiments of the present disclosure, there is provided a computer program product. The computer program product is tangibly stored on a non-transitory computer-readable medium and comprising computer-executable instructions that, when executed, cause a machine to implement a method for adding an effect. The method comprises: obtaining beat marker information of music of a video, the beat marker information indicating a change in a rhythm of the music. The method further comprises obtaining, based on the beat marker information, variable-speed information for the video, the variable-speed information indicating a playback speed of each video segment of the video. In addition, the method further comprises adding an effect to the video based on the variable-speed information.

The Summary is provided to introduce a selection of concepts in a simplified form that are further described below in the Detailed Description. This Summary is not intended to identify key features or essential features of the disclosure, nor is it intended to limit the scope of the disclosure.

### BRIEF DESCRIPTION OF THE DRAWINGS

The above and other features, advantages and aspects of embodiments of the present disclosure will become more apparent with reference to the following detailed description when taken in conjunction with the figures. In the figures, the same or like reference numerals denote the same or like elements, wherein:

FIG. 1 illustrates a schematic diagram of an example environment in which embodiments of the present disclosure may be implemented;

FIG. 2 illustrates a flow chart of a method for adding an effect according to some embodiments of the present disclosure;

FIG. 3 illustrates a schematic diagram of an example flow for adding an effect according to some embodiments of the present disclosure;

FIG. 4 illustrates a schematic diagram of an example timing for adding an effect according to some embodiments of the present disclosure;

FIG. 5 illustrates a schematic diagram of an example in which an effect is applied to beat markers of a video according to some embodiments of the present disclosure;

FIG. 6 illustrates a block diagram of an apparatus for adding an effect according to some embodiments of the present disclosure; and

FIG. 7 illustrates a block diagram of a device capable of implementing multiple embodiments of the present disclosure.

### DETAILED DESCRIPTION OF EMBODIMENTS

It may be appreciated that all user-related data involved in this solution should be obtained and used after authorization by the user. This means that, in the present technical solution, if the user's personal information needs to be used, before these data is obtained, the user's explicit consent and authorization are required, otherwise relevant data collection and use will not be performed. It should also be understood that in the implementation of the present technical solution, relevant laws and regulations should be strictly observed during the collection, use and storage of data, and necessary techniques and measures should be taken to ensure the safety of the user's data and the safe use of the data.

It may be appreciated that prior to using the technical solutions disclosed in the embodiments of the present disclosure, the user should be notified of the type, scope of use, use scenario, etc. of personal information involved in the present disclosure and authorization be obtained from the user in an appropriate manner according to relevant laws and regulations.

For example, in response to reception of the user's active request, prompt information is sent to the user to explicitly prompt the user that an operation he requests to perform needs to obtain and use his personal information. Accordingly, the user may autonomously select, according to the prompt information, whether to provide the personal information to software or hardware such as an electronic device, an application, a server or a storage medium, which executes the operations of the technical solution of the present disclosure.

As an optional but non-limiting implementation, in response to reception of the user's active request, the prompt message may be sent to the user, for example, in the form of a pop-up in which the prompt message may be presented in a text. In addition, the pop-up may further carry a selection control for the user to select “agree” or “disagree” to provide or not provide the personal information to the electronic device.

It is to be understood that the above-described processes of notifying and obtaining the user's authorization are merely illustrative and not be construed as limiting the implementations of the present disclosure, and that other ways of satisfying relevant laws and regulations may also be applied to the implementations of the present disclosure.

Hereinafter, embodiments of the present disclosure will be described in more detail with reference to the accompanying drawings. Although certain embodiments of the present disclosure have been illustrated in the accompanying drawings, it is to be understood that the present disclosure may be embodied in various forms and should not be construed as being limited to the embodiments set forth herein; rather, these embodiments are provided to enable the present disclosure to be understood more thoroughly and completely. It should be understood that the drawings and embodiments of the present disclosure are for illustrative purposes only and are not intended to limit the scope of the present disclosure.

In the depictions of the embodiments of the present disclosure, the term “include” and like words should be understood as being open-ended terms, i.e., mean “include, but not limited to”. The term “based on” should be understood as “based, at least in part, on”. The term “one embodiment” or “the embodiment” should be understood as “at least one embodiment”. The terms “first”, “second” and the like may refer to different or identical objects unless expressly stated otherwise. Other explicit and implicit definitions may also be included below.

As stated above, an effect in a video product can enhance a visual effect. The video effect provided by a current video platform is still limited as being taken as a pure decorative element, and the user decides on his own in which time period the effect is added. Although this way gives the user a certain degree of creativity, it usually ignores the degree of harmony between a time point at which the effect occurs and content of the video itself (e.g., soundtrack of the video). In many cases, the addition of the effect cannot match key elements such as video pacing and soundtrack, thereby affecting the overall expressiveness and emotional impact of the video work.

To this end, the present disclosure provides a method for adding an effect, which establishes an association between beat markers of the music of the video and the addition of the effect. In the solution according to the present disclosure, beat markers of the music of the video are determined based on the soundtrack of the video, variable speed information of the video is obtained based on the beat markers of the music, and thereby the addition of a variable speed effect to the video is implemented. By adjusting the playback speed of the video at the rhythm change points of the soundtrack of the video, this method not only combines the music beat markers of the video with the effect—making the addition of the effect to the video more harmonious and consistent with the original video—but also implements a playing method of controlling the video to change the speed by the effect. This enhances the visual impact and expressiveness of the video work, provide a brand-new effect experience to the user, and improve the user's experience.

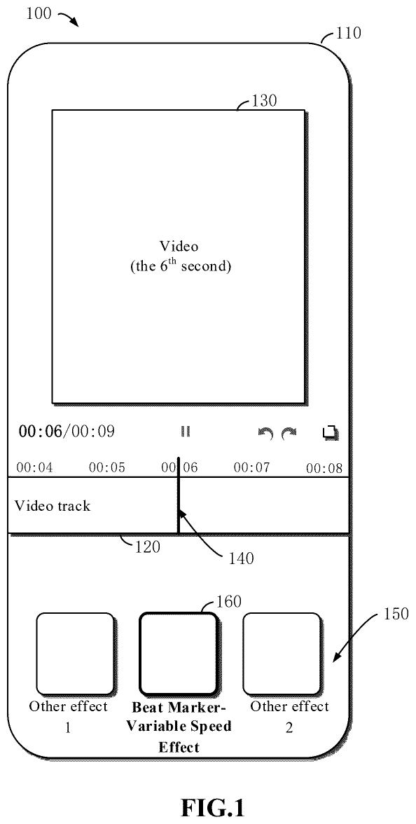

FIG. 1 illustrates a schematic diagram of an example environment 100 in which multiple embodiments of the present disclosure may be implemented. As shown in FIG. 1, a video track 120 for the user to edit the video is displayed in a display interface 110, an area above the video track 120 shows a display area 130 of a video playback picture corresponding to the video track 120, and different pictures on the display area 130 of the video playback picture can be switched by sliding a playhead 140, wherein the playhead indicates a frame which is being played on a current timeline. For example, the current playhead 140 is positioned at the 6 second, the display area 130 of the video playback picture is also playing a frame at the 6^{th} second.

Further referring to FIG. 1, below the video track 120 is an effect selection area 150 configured with effects such as Other Effect 1, Other Effect 2 and Beat Marker-Variable Speed Effect 160 for selection by the user. Other effects may be sticker effect, filter effect, 3D effect etc. The variable speed effect refers to a technical means to create a visual effect by adjusting the playback speed of video segments in a video editing process. Such an effect may allow the video segments to exhibit different speed states such as speed up, slow down, or even standstill when played, thereby providing the viewer with a unique visual experience. The variable speed effect can not only further enhance the rhythm sense of the video work, but also guide and attract the sight of the viewers of the video work, thereby improving the playback rate of the video work.

To further enhance the playfulness and expressiveness of the video work, the user may apply a beat marker-based variable speed effect to the video track 120 by selecting the Beat Marker-Variable Speed Effect 160.

In some embodiments, after the user selects the Beat Marker-Variable Speed Effect 160, a system (which may be an apparatus for adding an effect, for example) may first obtain beat marker information about the music of the video track 120. The beat marker information of the music may be used to indicate rhythm change points of the music. In some embodiments, the beat marker information of the music may comprise starting time, ending time, types of beat markers and timestamps of the beat markers of the music relative to the video.

In some embodiments, the beat marker information of the music may be downloaded from a server. After the system obtains the beat marker information of the music of the video, in order to achieve the addition of an effect, it is also necessary to obtain variable speed information about the video, wherein the variable speed information refers to a playback rate of some segments in the video. In some embodiments, the variable speed information may comprise information such as timestamps of variable speed video segments, types of speed variations (linear or non-linear) and a variable speed rate. For example, a music beat marker of a video is at 3.5 seconds of the video, the variable speed information about the video may be that a video segment from 0 to 1 second of the video is played at 1.0 times speed, and a video segment from 3 to 4 seconds is played linearly at 0.75 times speed.

In some embodiments, after obtaining the variable speed information about the video, the system may add such a variable speed effect based on music beat markers to the video according to the variable speed information of the video, thereby providing the user with a video effect that the playback speed is changed at the music beat markers. In some embodiments, some modules such as effect module in the system may be used to add effect information to the video, whereas some other modules such as video editing module in the system may be used to re-render the video based on the added effect information.

By adjusting the playback speed of the video at rhythm change points of the soundtrack of the video, this method not only combines the music beat markers of the video with the effect—making the addition of the video effect more harmonious and consistent with the original video—but also implements a playing method of controlling the video to change the speed by the effect. This enhances the visual impact and expressiveness of the video work, provide a brand-new effect experience to the user, and improve the user's experience.

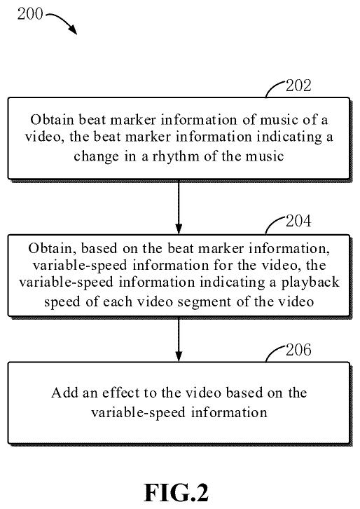

Hereinafter, a method according to an embodiment of the present disclosure will be described in detail with reference to FIG. 2 to FIG. 7. To facilitate understanding, specific data mentioned in the following description is exemplary and is not intended to limit the scope of the present disclosure. It is to be understood that the embodiments described below may also include additional acts not shown and/or may omit the acts shown, and the scope of the present disclosure is not limited in this respect.

FIG. 2 illustrates a flowchart of a method 200 for adding an effect according to some embodiments of the present disclosure. The method 200 may be performed by an apparatus for adding an effect. The apparatus may be, for example, a stand-alone apparatus or system. The apparatus may be implemented by means of software and/or hardware. Next, the method 200 is schematically described by taking the apparatus for adding an effect as an execution subject. The method 200 comprises block 202, block 204, and block 206.

As shown in FIG. 2, at block 202, beat marker information of music of a video is obtained, wherein the beat marker information may indicate changes in the rhythm of the music. Referring to FIG. 1, when the user selects the Beat Marker-Variable Speed Effect 160, the system (which for example may be an apparatus for adding an effect) may first obtain the beat marker information about the music of the video track 120. The beat marker information of the music may be used to indicate changes in the rhythm of the music. In some embodiments, the beat marker information of the music may comprise a starting time, an ending time, types of beat markers and an array of timestamps of the beat markers of the music relative to the video.

At block 204, variable speed information for the video is obtained based on the beat marker information, wherein the variable speed information indicates a playback speed of each video segment of the video. In some embodiments, the beat marker information of the music may be downloadable from a server. After obtaining the beat marker information of the music of the video, the system also needs to obtain the variable speed information about the video in order to achieve the addition of the effect, wherein the variable speed information refers to the playback speed of some segments in the video. In some embodiments, the variable speed information may comprise information such as a timestamp of a variable speed video segment, a type of speed variation (linear or non-linear) and a variable speed rate. For example, a music beat marker of a video is at 3.5 seconds of the video, the variable speed information about the video may be that a video segment from 0 to 1 second of the video is played at 1.0 times speed, whereas a video segment from 3 to 4 seconds is played linearly at 0.75 times speed.

At block 206, an effect is added to the video based on the variable speed information. In some embodiments, after obtaining the variable speed information about the video, the system may add such a variable speed effect based on music beat markers to the video according to the variable speed information of the video, so that the video can provide the user with an effect that the playback speed is changed at the music beat markers.

By adjusting the playback speed of the video at rhythm change points of the soundtrack of the video, this method not only combines the music beat markers of the video with the effect—making the addition of the video effect more harmonious and consistent with the original video—but also implements a playing method of controlling the video to change the speed by the effect. This enhances the visual impact and expressiveness of the video work, provide a brand-new effect experience to the user, and improve the user's experience.

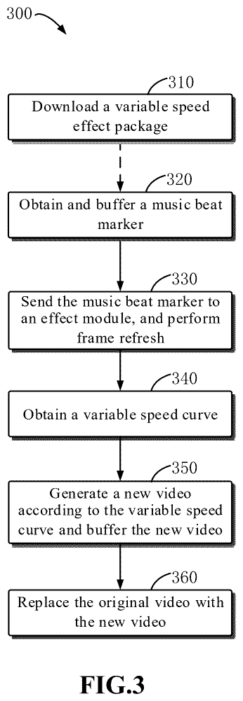

Continuing from FIG. 1, after the user selects the Beat Marker-Variable Speed Effect 160 for the video, the system may implement the addition of the variable speed effect to the video based on an example flow shown in FIG. 3. FIG. 3 illustrates a schematic diagram of an example flow 300 for adding an effect according to some embodiments of the present disclosure. Referring to FIG. 3, after the user selects the Beat Marker-Variable Speed Effect 160 for the video, at 310, the system may download a variable speed effect package from the server. In some embodiments, the variable speed effect package comprises configuration information for performing speed variation for some frames in the video. Alternatively, after the user selects the Beat Marker-Variable Speed Effect 160, the system may also determine, via a built-in draft, whether to perform a playing method process of the beat marker-based variable speed effect. If YES, the system will continue to subsequently process the variable speed effect of the video. The built-in draft here is equivalent to the system buffering the video and processing information of the video, wherein the processing information comprises information about an operation on the video such as adding a filter, extending a duration etc. Alternatively, the effect may also be of other effects, such as a filter, a sticker, etc.

As shown in FIG. 3, at 320, the system may obtain music beat markers and buffer the music beat markers. In some embodiments, the beat marker information of the music may be obtained from a server by the system. In some embodiments, the system may analyze the obtained beat marker information and buffer the obtained beat marker information in the system as data in JSON format. In some embodiments, the beat marker information may comprise a starting time, an ending time, a beat marker timestamp array and a beat marker type of the music of the video relative to the video. The beat marker timestamp array is an ordered array composed of a series of timestamp values and used for marking the beat marker information of music. In the array, each element represents a specific timestamp.

Referring to FIG. 3, after the music beat marker information is obtained, the music beat marker may be sent to an effect module and the frame refresh may be performed at 330. In some embodiments, a local address of the downloaded variable speed effect package also needs to be written into a data structure file before the music beat marker is transferred to the effect module. For example, the variable speed effect package may be buffered at a local address of the system and written to a JSON file with the beat marker information, and this JSON file may be transferred to the effect module.

In some embodiments, in the process of transferring the effect information and the beat marker information to the effect module, the processing information in the above process of transferring the JSON file may also be buffered, thereby helping the user to cancel or redo the current operation behavior on the video.

In some embodiments, in order to subsequently accurately add an effect at a specified frame position, it is also necessary to perform frame refresh for the video, i.e., divide the video into a plurality of frames and align the audio with the video temporally, and refresh to check whether each frame of picture is correct, which can lay a foundation for subsequently adding an effect at a specified positon in the video. Meanwhile, the system may also buffer relevant data during the frame refresh. Alternatively, if certain frames are adjusted, the frame refresh will involve modifying or replacing a specific frame and then refreshing to see an effect after the modification. For example, after a color of a certain frame is adjusted or an effect is added, the picture is refreshed to confirm whether the modification is as expected.

Further referring to FIG. 3, after the frame refreshing for the video, a variable speed curve may be obtained at 340. The variable speed curve may be used to control the playback speed of the video. A conventional adjustment of the video playback speed might be only simply setting a multiple, such as 0.5×speed or 2×speed. A more complex playback speed variation may be implemented using the variable speed curve. For example, at the beginning of the video, the variable speed curve may be set to speed up gradually, allowing the video to slowly ramp up from a normal speed to 1.5 times the speed, thereby creating a feeding that the viewer gets immersed gradually. Alternatively, in a climax part of a plot of the video, it is possible to, by setting the variable speed curve to have a process in which the speed slows down abruptly first and then speeds up, enable the user to capture key picture details more clearly, and then enable the video to return to the normal rhythm.

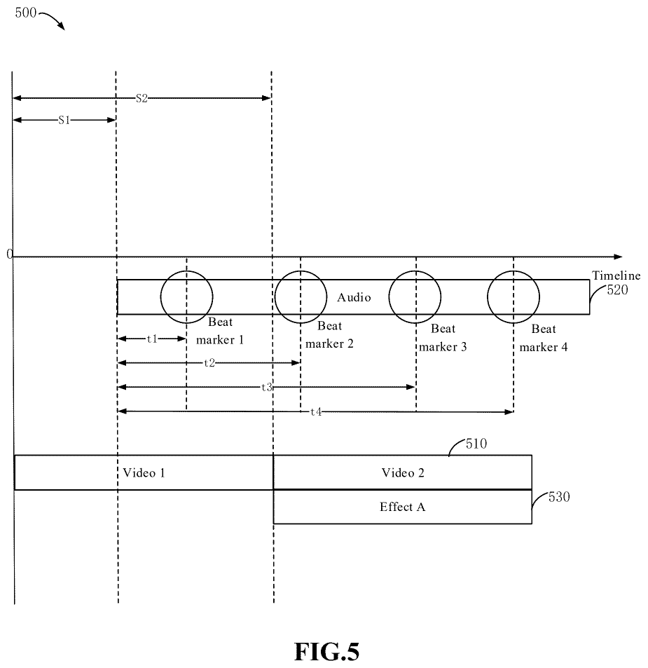

Further referring to FIG. 3, after the variable speed curve is obtained, a new video may be generated according to the variable speed curve and buffered at 350. After the system obtains the variable speed information (or the variable speed curve), the variable speed information may be returned to the effect module via 414, and the effect module adds an effect to the video according to the variable speed curve and according to a specified frame position determined according to the beat marker position. FIG. 5 illustrates a schematic diagram of an example 500 of applying an effect to beat markers of a video according to some embodiments of the present disclosure. With reference to FIG. 5, for video 510, a variable change effect may be applied to all of beat marker positon 2, beat marker position 3 and beat marker position 4 so that a new video may be generated with the variable speed effect being added at the beat marker positions.

Further referring to FIG. 3, at 360, the original video is replaced with the new video. When the system adds the variable speed effect to the original video, the new video added with the variable speed effect may be used to replace the original video, so that the user can get the new video with the variable speed effect at the beat marker positions.

By adjusting the playback speed of the video at rhythm change points of the soundtrack of the video, this method not only combines the music beat markers of the video with the effect—making the addition of the video effect more harmonious and consistent with the original video—but also implements a playing method of controlling the video to change the speed by the effect. This enhances the visual impact and expressiveness of the video work, provide a brand-new effect experience to the user, and improve the user's experience.

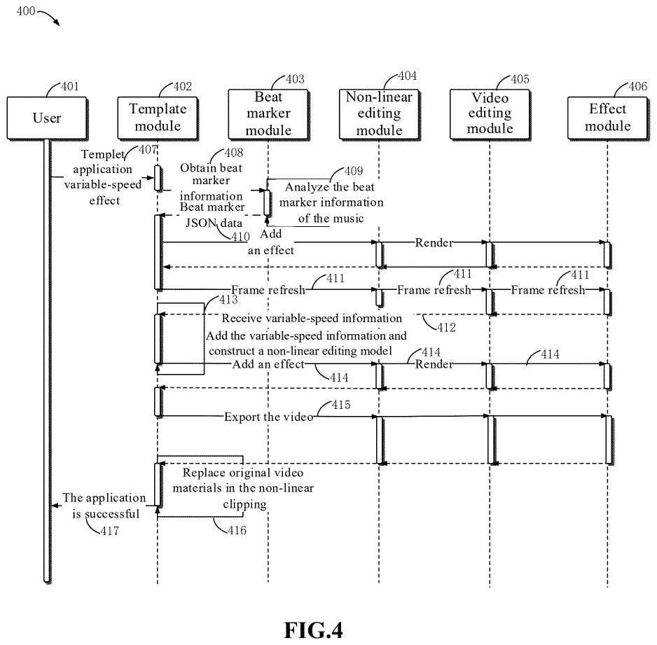

Continuing with FIG. 1, after the user selects the Beat Marker-Variable Speed Effect 160 for the video, the system may implement the addition of the variable speed effect to the video based on an example flow shown in FIG. 4. FIG. 4 illustrates a schematic diagram of an example timing 400 for adding an effect according to some embodiments of the present disclosure. A template module 402, a beat marker module 403, a non-linear editing module 404, a video editing module 405 and an effect module shown in FIG. 4 all are modules in an apparatus (system) for adding an effect. In some embodiments, the template module 402 may be taken as a functional template in a specific case (where the use selects the effect), and comprise a relevant flow and resources to achieve a specific effect. In some embodiments, the beat marker module 403 may be used to write the beat marker information obtained by the system to a file with a specific data structure.

The non-linear editing module 404 is a set of tools for video and audio editing. Unlike the traditional linear editing (e.g., magnetic tape editing, where materials must be arranged in a sequential order), non-linear editing allows user to access and edit the materials in a non-sequential manner. In the non-linear editing module 404, materials such as videos, audios etc. are digitized and stored on computer hard disks or other storage device, and the user may freely perform operations such as moving, clipping, adding the effect, etc. on the timeline without affecting the integrity of the original materials. In some embodiments, the non-linear editing module 404 may be used to buffer processing information as well as the video in the process of adding the effect to the video by the system. The video editing module 405 is a core part in video editing and is a set of tools and functions for processing the video materials. In some embodiments, the video editing module 405 may be used to render the video.

After the user selects the Beat Marker-Variable Speed Effect 160 for the video, the system downloads a variable speed effect package. In some embodiments, the system may download the variable speed effect package from the server. Alternatively, with reference to FIG. 1 and FIG. 4, after the user 401 selects the Beat Marker-Variable Speed Effect 160 (i.e., the template module 402 receives a template application variable speed effect via 407), the system may also determine, via a built-in draft, whether to perform a playing method process based on the beat marker-variable speed effect. If YES, the system will continue to subsequently process the variable speed effect of the video. The built-in draft here is equivalent to the system buffering the video and processing information of the video, wherein the processing information comprises information about an operation on the video such as adding a filter, extending a duration etc. Alternatively, the effect may also be of other effects, such as a filter, a sticker, etc.

In order to make the addition of the variable speed effect more harmonious with the content of the video, a position where the variable speed effect is added may be determined based on the beat marker information of the video. As shown in FIG. 4, the beat marker module 403 of the system may obtain the beat marker information via 408. In some embodiments, the beat marker information may be obtained from a server. The beat marker module 403 may, at 409, analyze the obtained beat marker information and transfer the obtained beat marker information as JSON formatted data to the template module 402 via 410. In some embodiments, the beat marker information may comprise information such as a starting time, an ending time, a beat marker timestamp array and a beat marker type of the music of the video relative to the video. In some embodiments, a JSON file of the beat marker information may comprise a duration while the effect is applied in the original video in a measure unit ms. For example, if the video duration is 0 -10000 ms and the effect is loaded to a range of 3000-7000 ms, then the duration while the effect is applied to the original video is 4000 ms. The JSON file may further comprise a starting time in the measure unit ms of the music relative to the video segment. The JSON file may further comprise a beat marker timestamp array, in the measure unit ms. In addition, the JSON file may further comprise a type of the beat marker.

Referring to FIG. 5, FIG. 5 illustrates a schematic diagram of an example in which effect A 530 is applied to a video segment 510. As shown in FIG. 5, S1 is the starting time of an audio 520, S2 is the starting time of a video 510. t2, t3 and t4 are respective time at which beat marker 2, beat marker 3 and beat marker 4 of the audio 520 are obtained relative to the starting time of the audio 520, and then the timestamp array of the beat marker time at which the effect A is applied to the video 510 is [t2+S1−S2, t3+S1−S2, . . . ]. Alternatively, the effect A may be an effect other than the variable speed effect, such as a sticker, filter, etc.

After the music beat marker information of the video is obtained, the music beat marker information may be sent to the effect module for adding the effect to the video. In some embodiments, frame refresh may also be performed for the video in this process. Referring to FIG. 4, in some embodiments, before the template module 402 transfers the music beat marker to the effect module 406, a local address of the downloaded variable speed effect package also needs to be written into a data structure file. For example, the variable speed effect package may be stored at a local address of the system and written to a JSON file with the beat marker information, and this JSON file may be transferred to the effect module along with the template module 402.

In some embodiments, in a process of transferring the effect information and the beat marker information to the effect module, the non-linear editing module 404 may buffer the processing information during the above process, thereby helping the user to cancel or redo the current operation behavior on the video.

In some embodiments, in order to subsequently accurately add the effect at a specified frame position, it is also necessary to perform frame refresh for the video via 411. That is, dividing the video into a plurality of frames sot that the non-linear editing module 404, the video editing module 405 and the effect module 406 determine the position of each frame, align the audio with the video temporally, and refresh to check whether each frame of image is correct. This can lay a foundation for subsequently adding the effect at a specified positon in the video. Meanwhile, the non-linear editing module 404 may also buffer relevant data during the frame refresh. Alternatively, if certain frames are adjusted, the frame refresh will involve modifying or replacing a specific frame and then refreshing to see an effect after the modification. For example, after a color of a certain frame is adjusted or an effect is added, the picture is refreshed to confirm whether the modification is as expected.

After the system has the beat marker information, it is also necessary to obtain the variable speed information based on the beat markers, namely, obtain a variable speed curve. The variable speed curve (also referred to as a speed curve) is a curve used to describe a law of variation of a speed of an object over time. It takes time as a horizontal axis and speed as a vertical axis, and each point on the curve represents a magnitude of the speed of the object at a corresponding time point. The variable speed curve may be used to control the playback speed of the video. A conventional adjustment to the video playback speed might be only simply setting a multiple, such as 0.5×speed or 2×speed. A more complex playback speed variation may be achieved using the variable speed curve. For example, at the starting segment part of the video, the variable speed curve may be set to speed up gradually, allowing the video to slowly ramp up from a normal speed to 1.5 times the speed, thereby creating a feeling that the viewer gets immersed gradually. Alternatively, in a climax part of a plot of the video, it is possible to, by setting the variable speed curve to have a process in which the speed slows down abruptly first and then speeds up, enable the user to capture key image details more clearly, and then enable the video to return to the normal rhythm.

Referring to FIG. 4, after obtaining the JSON file with the beat marker information and the address of the variable speed effect package, the effect module 406 may extract relevant variable speed information by analysis and transfer the relevant variable speed information to the template module 402 via 412. Thereby, enabling the template module 402 to prepare at 413 for adding the variable speed information to the video and construct the non-linear editing model. In some embodiments, the JSON file with the variable speed information may comprise a variable speed segment which may be determined based on the beat marker information, and returned only when the user selects the beat marker-variable speed effect. The JSON file with the variable speed information may further comprise a playback speed for each video segment. Assuming that the music markers are at 1 second, 2.5 seconds and 5.5 seconds, the original video will be played in a way that a video segment from 0 to 2 seconds is played at a 2×speed, a video segment from 2 to 4 seconds is played at a 0.5×speed, and a video segment from 4 to 7 seconds is played at a 3×speed. In some embodiments, the variable speed information further comprises a type of speed variation, such as a linear speed variation or a non-linear speed variation.

After the variable speed curve for the video is obtained, a new video may be generated according to the variable speed curve and buffered. In some embodiment, after the template module 402 obtains the variable speed information (or the variable speed curve), the variable speed information may be returned to the effect module 406 via 414, and the effect module 406 adds an effect to the video according to the variable speed curve and according to a specified frame position determined according to the beat marker position. With reference to FIG. 5, for video 510, a variable change effect may be applied to all of beat marker positon 2, beat marker position 3 and beat marker position 4. Then, the video is re-rendered by the video editing module 405 based on the added variable speed effect so that a new effect-rendered video can be derived by 415.

In some embodiments, when a new video with the beat marker-based application variable speed effect is obtained, the original video may be replaced with the new video. Referring to FIG. 4, the newly generated video may then be used to replace the video material in the constructed non-linear editing model at 416. Next, at 417, when the application of the variable speed effect to the video succeeds, a notification that the application of the beat marker-variable speed effect has already been completed may be sent to the user. It should be appreciated that FIG. 3, FIG. 4, and FIG. 5 are merely examples of embodiments of the present disclosure and are not intended to limit the method according to the present disclosure.

By adjusting the playback speed of the video at rhythm change points of the soundtrack of the video, this method not only combines the music beat markers of the video with the effect—making the addition of the video effect more harmonious and consistent with the original video—but also implements a playing method of controlling the video to change the speed by the effect. This enhances the visual impact and expressiveness of the video work, provide a brand-new effect experience to the user, and improve the user's experience.

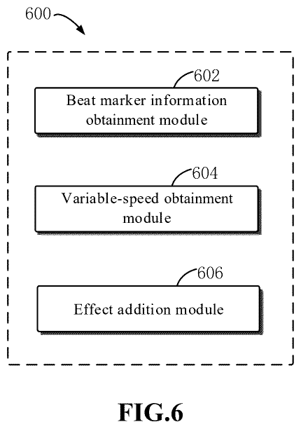

FIG. 6 illustrates a block diagram of an apparatus 600 for adding an effect according to some embodiments of the present disclosure. As shown in FIG. 6, the apparatus 600 comprises an information obtainment module 602 configured to obtain beat marker information of music of a video, wherein the beat marker information indicates a change in a rhythm of the music. The apparatus 600 further comprises a variable speed information obtaining module 604 configured to obtain variable speed information for the video based on the beat marker information, wherein the variable speed information indicates a playback speed of each video segment of the video. In addition, the apparatus 600 further comprises an effect addition module 606 configured to add an effect to the video based on the variable-speed information.

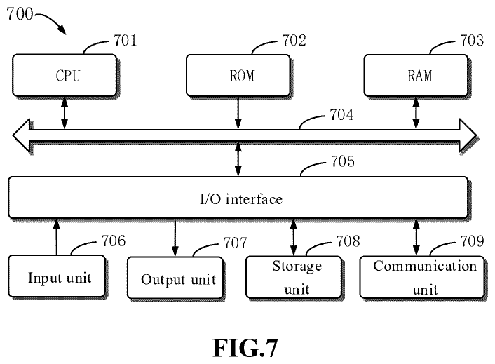

FIG. 7 illustrates a block diagram of a device 700 capable of implementing embodiments of the present disclosure. As shown in FIG. 7, the device 700 comprises a central processing unit (CPU) and/or graphics processing unit (GPU) 701 which may perform various suitable acts and processes in accordance with computer program instructions stored in a Read Only Memory (ROM) 702 or computer program instructions loaded from a storage unit 708 into a Random Access Memory (RAM) 703. In the RAM 703, various programs and data needed by the operation of the device 700 are also stored. The CPU/GPU 701, the ROM 702, and the RAM 703 are connected to one another via a bus 704. An input/output (I/O) interface 705 is also coupled to the bus 704. Although not shown in FIG. 7, the device 700 may further comprise a coprocessor.

Multiple components in the device 700 may be connected to the I/O interface 705: an input unit 706 including, for example, a keyboard, a mouse, etc. ; an output unit 707 including various displays, speakers etc. ; a storage unit 708 such as a magnetic disk, a CD etc. ; and a communication unit 709 such as a network card, a modem, a wireless communication transceiver, etc. The communication unit 709 allows the device 700 to exchange information/data with other devices over a computer network, such as the Internet, and/or various telecommunication networks.

The methods or processes described above may be performed by CPU/GPU 701. For example, in some embodiments, the methods may be implemented as a computer software program tangibly embodied on a machine-readable medium, such as the storage unit 708. In some embodiments, part or all of the computer program may be loaded and/or installed on the device 700 via the ROM 702 and/or the communication unit 709. When the computer program is loaded into the RAM 703 and executed by the CPU/GPU 701, one or more steps or actions in the methods or processes described above may be performed.

In some embodiments, the methods and processes described above may be implemented as a computer program product. The computer program product may include a computer-readable storage medium having computer-readable program instructions embodied thereon for performing the aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer disk, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals itself, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language and conventional procedural programming languages. The computer readable program instructions may execute entirely on the user's computer, partly on the user's computer, as a stand-alone software package, partly on the user's computer and partly on a remote computer or entirely on the remote computer or server. In the scenario involving the remote computer, the remote computer may be connected to the user's computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to perform aspects of the present disclosure.

These computer readable program instructions may be provided to a processing unit of a general-purpose computer, a special-purpose computer, or other programmable data processing apparatus to produce a machine, such that the instructions, when executed via the processing unit of the computer or other programmable data processing apparatus, create means for implementing the functions/acts specified in one or more blocks in the flowcharts and/or block diagrams. These computer readable program instructions may also be stored in a computer readable storage medium and cause a computer, a programmable data processing apparatus, and/or other devices to function in a specific manner, such that the computer readable storage medium having instructions stored therein comprises an article of manufacture including instructions which implement aspects of the functions/acts specified in one or more blocks in the flowcharts and/or block diagrams.

The computer readable program instructions may also be loaded onto a computer, other programmable data processing apparatus, or other devices to cause a series of operational steps to be performed on the computer, other programmable apparatus or other device to produce a computer-implemented process, such that the instructions executed on the computer, other programmable apparatus, or other devices implement the functions/acts specified in one or more blocks in the flowcharts and/or block diagrams.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special-purpose hardware-based systems that perform the specified functions or acts, or implemented by combinations of special-purpose hardware and computer instructions.

The above depictions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Some example implementations of the present disclosure are listed below.

Example 1. A method for adding an effect, comprising:
obtaining beat marker information of music of a video, the beat marker information indicating a change in a rhythm of the music;
obtaining, based on the beat marker information, variable-speed information for the video, the variable-speed information indicating a playback speed of each video segment of the video; and
adding an effect to the video based on the variable-speed information.

Example 2. The method according to Example 1, wherein obtaining the beat marker information of the music of the video comprises:
in response to detecting a user's touch of a first control associated with the video, obtaining the beat marker information corresponding to the music of the video, the beat marker information comprising a starting time, an ending time, a beat marker timestamp array and a beat marker type of the music relative to the video, and the beat marker timestamp array indicating a timestamp of each beat marker.

Example 3. The method according to any of Examples 1-2, wherein obtaining, based on the beat marker information, the variable-speed information for the video comprises:
downloading a variable-speed effect package from a server, and obtaining a local address of the variable-speed effect package;
writing the local address of the variable-speed effect package and the beat marker information into a data structure file; and
obtaining, by an effect module, the variable-speed information based on the data structure file, the variable-speed information comprising a variable-speed segment, a variable-speed type and a variable-speed rate for the video.

Example 4. The method according to any of Examples 1-3, further comprising:
dividing the video into a plurality of video frames; and
determining positioning of each frame of the plurality of video frames in the video, the positioning indicating positions of the plurality of video frames in the video.

Example 5. The method according to any of Examples 1-4, wherein adding the effect to the video based on the variable-speed information comprises:
adding the effect to the video based on the variable-speed information and the positioning of each frame.

Example 6. The method according to any of Examples 1-5, further comprising:
determining a non-linear editing model based on the variable-speed information and the video, the non-linear editing model buffering the variable-speed information, the video and the beat marker information.

Example 7. The method according to any of Examples 1-6, further comprising:
re-rendering, by a video editing module, the video added with the effect; and
buffering, by the non-linear editing module, the re-rendered video.

Example 8. The method according to any of Examples 1-7, further comprising:
exporting the re-rendered video added with the effect; and
replacing the buffered video in the non-linear editing module based on the re-rendered video added with the effect.

Example 9. The method according to any of Examples 1-8, further comprising:
in response to detecting completion of adding the effect to the video, sending a message indicating the completion of adding the effect to the user.

Example 10. An apparatus for adding an effect, comprising:
a beat marker information obtainment module configured to obtain beat marker information of music of a video, the beat marker information indicating a change in a rhythm of the music;
a variable-speed information obtainment module configured to obtain, based on the beat marker information, variable-speed information for the video, the variable-speed information indicating a playback speed of each video segment of the video; and
an effect addition module configured to add an effect to the video based on the variable-speed information.

Example 11. The apparatus according to Example 10, wherein the beat marker information obtaining module comprises:
an obtainment module configured to, in response to detecting a user's touch of a first control associated with the video, obtain the beat marker information corresponding to the music of the video, the beat marker information comprising a starting time, an ending time, a beat marker timestamp array and a beat marker type of the music relative to the video, and the beat marker timestamp array indicating a timestamp of each beat marker.

Example 12. The apparatus according to any of Example 10-11, wherein the variable-speed information obtaining module comprises:
a downloading module configured to download a variable-speed effect package from a server, and obtain a local address of the variable-speed effect package;
a writing module configured to write the local address of the variable-speed effect package and the beat marker information into a data structure file; and
an obtaining module configured to obtain, by an effect module, the variable-speed information based on the data structure file, the variable-speed information comprising a variable-speed segment, a variable-speed type and a variable-speed rate for the video.

Example 13. The apparatus according to any of Examples 10-12, further comprising:
a video frame division module configured to divide the video into a plurality of video frames; and
a first determination module configured to determine positioning of each frame of the plurality of video frames in the video, the positioning indicating positions of the plurality of video frames in the video.

Example 14. The apparatus according to any of Examples 10-13, wherein the effect addition module comprises:
a first addition module configured to add the effect to the video based on the variable-speed information and the positioning of each frame.

Example 15. The apparatus according to any of Examples 10-14, further comprising:
a second determination module configured to determine a non-linear editing model based on the variable-speed information and the video, the non-linear editing model buffering the variable-speed information, the video and the beat marker information.

Example 16. The apparatus according to any of Examples 10-15, further comprising:
a second rendering module configured to re-render, by a video editing module, the video added with the effect; and
a second buffering module configured to buffer, by the non-linear editing module, the re-rendered video.

Example 17. The apparatus according to any of Examples 10-16, further comprising:
an exporting module configured to export the re-rendered video added with the effect; and
a replacing module configured to replace the buffered video in the non-linear editing module based on the re-rendered video added with the effect.

Example 18. The apparatus according to any of Examples 10-17, further comprising:
a sending module configured to, in response to detecting completion of adding the effect to the video, send a message indicating the completion of adding the effect to the user.

Example 19. An electronic device, comprising:
a processor; and
a memory coupled to the processor, the memory having instructions stored therein that, when performed by the processor, cause the electronic device to perform actions, the actions comprising:
obtaining beat marker information of music of a video, the beat marker information indicating a change in a rhythm of the music;
obtaining, based on the beat marker information, variable-speed information for the video, the variable-speed information indicating a playback speed of each video segment of the video; and
adding an effect to the video based on the variable-speed information.

Example 20. The electronic device of Example 19, wherein obtaining the beat marker information of the music of the video comprises:
in response to detecting a user's touch of a first control associated with the video, obtaining the beat marker information corresponding to the music of the video, the beat marker information comprising a starting time, an ending time, a beat marker timestamp array and a beat marker type of the music relative to the video, and the beat marker timestamp array indicating a timestamp of each beat marker.

Example 21. The electronic device according to any of Examples 19-20, wherein obtaining, based on the beat marker information, the variable-speed information for the video comprises:
downloading a variable-speed effect package from a server, and obtaining a local address of the variable-speed effect package;
writing the local address of the variable-speed effect package and the beat marker information into a data structure file; and
obtaining, by an effect module, the variable-speed information based on the data structure file, the variable-speed information comprising a variable-speed segment, a variable-speed type and a variable-speed rate for the video.

Example 22. The electronic device according to any of Examples 19-21, further comprising:
dividing the video into a plurality of video frames; and
determining positioning of each frame of the plurality of video frames in the video, the positioning indicating positions of the plurality of video frames in the video.

Example 23. The electronic device according to any of Examples 19-22, wherein adding the effect to the video based on the variable-speed information comprises:
adding the effect to the video based on the variable-speed information and the positioning of each frame.

Example 24. The electronic device according to any of Examples 19-23, further comprising:
determining a non-linear editing model based on the variable-speed information and the video, the non-linear editing model buffering the variable-speed information, the video and the beat marker information.

Example 25. The electronic device according to any of Examples 19-24, further comprising:
re-rendering, by a video editing module, the video added with the effect; and
buffering, by the non-linear editing module, the re-rendered video.

Example 26. The electronic device according to any of Examples 19-25, further comprising:
exporting the re-rendered video added with the effect; and
replacing the buffered video in the non-linear editing module based on the re-rendered video added with the effect.

Example 27. The electronic device according to any of Examples 19-26, further comprising:
in response to detecting completion of adding the effect to the video, sending a message indicating the completion of adding the effect to the user.

Example 28. A computer-readable storage medium having stored thereon computer-executable instructions, wherein the computer-executable instructions are performed by a processor to perform the method according to any one of Examples 1 to 9.

Example 29. A computer program product tangibly stored on a computer-readable medium and comprising computer-executable instructions, the computer-executable instructions, when performed by an apparatus, cause the apparatus to perform the method according to any one of Examples 1 to 9.

Although the subject matter has been described in language specific to structural features and/or methodological actions, it should be understood that the subject matters specified in the appended claims are not limited to the specific features or actions described above. Rather, the specific features and actions described above are disclosed as example forms of implementing the claims.

I/We claim:

1. A method for adding an effect, comprising:
obtaining beat marker information of music of a video, the beat marker information indicating a change in a rhythm of the music;
obtaining, based on the beat marker information, variable-speed information for the video, the variable-speed information indicating a playback speed of each video segment of the video; and
adding an effect to the video based on the variable-speed information.

2. The method according to claim 1, wherein obtaining the beat marker information of the music of the video comprises:
in response to detecting a user's touch of a first control associated with the video, obtaining the beat marker information corresponding to the music of the video, the beat marker information comprising a starting time, an ending time, a beat marker timestamp array and a beat marker type of the music relative to the video, and the beat marker timestamp array indicating a timestamp of each beat marker.

3. The method according to claim 2, wherein obtaining, based on the beat marker information, the variable-speed information for the video comprises:
downloading a variable-speed effect package from a server, and obtaining a local address of the variable-speed effect package;
writing the local address of the variable-speed effect package and the beat marker information into a data structure file; and
obtaining, by an effect module, the variable-speed information based on the data structure file, the variable-speed information comprising a variable-speed segment, a variable-speed type and a variable-speed rate for the video.

4. The method according to claim 3, further comprising:
dividing the video into a plurality of video frames; and
determining positioning of each frame of the plurality of video frames in the video, the positioning indicating positions of the plurality of video frames in the video.

5. The method according to claim 4, wherein adding the effect to the video based on the variable-speed information comprises:
adding the effect to the video based on the variable-speed information and the positioning of each frame.

6. The method according to claim 5, further comprising:
determining a non-linear editing model based on the variable-speed information and the video, the non-linear editing model buffering the variable-speed information, the video and the beat marker information.

7. The method according to claim 6, further comprising:
re-rendering, by a video editing module, the video added with the effect; and
buffering, by the non-linear editing module, the re-rendered video.

8. The method according to claim 7, further comprising:
exporting the re-rendered video added with the effect; and
replacing the buffered video in the non-linear editing module based on the re-rendered video added with the effect.

9. The method according to claim 1, further comprising:
in response to detecting completion of adding the effect to the video, sending a message indicating the completion of adding the effect to the user.

10. An electronic device, comprising:
a memory and a processor;
wherein the memory is configured to store one or more computer instructions which, when executed by the processor, cause the processor to:
obtain beat marker information of music of a video, the beat marker information indicating a change in a rhythm of the music;
obtain, based on the beat marker information, variable-speed information for the video, the variable-speed information indicating a playback speed of each video segment of the video; and
add an effect to the video based on the variable-speed information.

11. The device according to claim 10, wherein the instructions causing the processor to obtain the beat marker information of the music of the video comprise instructions causing the processor to:
in response to detecting a user's touch of a first control associated with the video, obtain the beat marker information corresponding to the music of the video, the beat marker information comprising a starting time, an ending time, a beat marker timestamp array and a beat marker type of the music relative to the video, and the beat marker timestamp array indicating a timestamp of each beat marker.

12. The device according to claim 11, wherein the instructions causing the processor to obtain, based on the beat marker information, the variable-speed information for the video comprise instructions causing the processor to:
download a variable-speed effect package from a server, and obtain a local address of the variable-speed effect package;
write the local address of the variable-speed effect package and the beat marker information into a data structure file; and
obtain, by an effect module, the variable-speed information based on the data structure file, the variable-speed information comprising a variable-speed segment, a variable-speed type and a variable-speed rate for the video.

13. The device according to claim 12, further comprising instructions causing the processor to:
divide the video into a plurality of video frames; and
determine positioning of each frame of the plurality of video frames in the video, the positioning indicating positions of the plurality of video frames in the video.

14. The device according to claim 13, wherein the instructions causing the processor to add the effect to the video based on the variable-speed information comprise instructions causing the processor to:
add the effect to the video based on the variable-speed information and the positioning of each frame.

15. The device according to claim 14, further comprising instructions causing the processor to:
determine a non-linear editing model based on the variable-speed information and the video, the non-linear editing model buffering the variable-speed information, the video and the beat marker information.

16. The device according to claim 15, further comprising instructions causing the processor to:
re-render, by a video editing module, the video added with the effect; and
buffer, by the non-linear editing module, the re-rendered video.

17. The device according to claim 16, further comprising instructions causing the processor to:
export the re-rendered video added with the effect; and
replace the buffered video in the non-linear editing module based on the re-rendered video added with the effect.

18. The device according to claim 10, further comprising instructions causing the processor to:
in response to detecting completion of adding the effect to the video, send a message indicating the completion of adding the effect to the user.

19. A non-transitory computer-readable medium comprising instructions stored thereon which, when executed by a processor, cause the processor to:
obtain beat marker information of music of a video, the beat marker information indicating a change in a rhythm of the music;
obtain, based on the beat marker information, variable-speed information for the video, the variable-speed information indicating a playback speed of each video segment of the video; and
add an effect to the video based on the variable-speed information.

20. The medium according to claim 19, wherein the instructions causing the processor to obtain the beat marker information of the music of the video comprise instructions causing the processor to:
in response to detecting a user's touch of a first control associated with the video, obtain the beat marker information corresponding to the music of the video, the beat marker information comprising a starting time, an ending time, a beat marker timestamp array and a beat marker type of the music relative to the video, and the beat marker timestamp array indicating a timestamp of each beat marker.
